(19) United States
(12) Patent Application Publication
(10) Pub. No.: US 2010/0053182 A1
(43) Pub. Date: Mar. 4, 2010

(54) METHOD OF COMPENSATING IMAGE DATA, APPARATUS FOR COMPENSATING IMAGE DATA, AND DISPLAY DEVICE HAVING THE SAME

(75) Inventors: Byung-Kil JEON, Anyang-si (KR); Woo-Chul Kim, Seoul (KR)

Correspondence Address: H.C. PARK & ASSOCIATES, PLC, 8500 LEESBURG PIKE, SUITE 7500, VIENNA, VA, 22182, US

(73) Assignee: Samsung Electronics Co., Ltd., Suwon-si (KR)

(21) Appl. No.: 12/419,736

(22) Filed: Apr. 7, 2009

(30) Foreign Application Priority Data
Aug. 27, 2008 (KR) 2008-83714

(51) Int. Cl. G09G 5/36

(52) U.S. Cl. 345/536; 345/557

(57) ABSTRACT

In a method of compensating image data, a lookup table (LUT) memory storing compensating data that corresponds to received image data is disabled when the received image data is substantially the same as previous image data that is stored in a cache memory. Compensating data that corresponds to the previous image data stored in the cache memory is outputted as compensating data that corresponds to the received image data. The previous image data stored in the cache memory and the compensating data are maintained.

### CROSS REFERENCE TO RELATED APPLICATION

This application claims priority from and the benefit of Korean Patent Application No. 2008-83714, filed on Aug. 27, 2008, which is hereby incorporated by reference for all purposes as if fully set forth herein.

### BACKGROUND OF THE INVENTION

1. Field of the Invention

The present invention relates to a method of compensating image data, an apparatus for compensating the image data, and a display device having the apparatus. More particularly, the present invention relates to a method of compensating image data, which is capable of decreasing power consumption, an apparatus for compensating the image data, and a display device having the apparatus.

2. Discussion of the Background

A liquid crystal display (LCD) device, in general, includes an LCD panel and a backlight assembly. The LCD panel displays an image using light transmittance of a liquid crystal. The backlight assembly supplies the LCD panel with light.

The LCD panel includes an array substrate, a color filter substrate, and a liquid crystal layer. The array substrate includes a plurality of pixel electrodes and a plurality of thin film transistors that is electrically connected to the pixel electrodes. The color filter substrate includes a common electrode and a plurality of color filters. The liquid crystal layer is interposed between the array substrate and the color filter substrate. An electric field is generated between the pixel electrodes and the common electrode to alter an arrangement of liquid crystal molecules of the liquid crystal layer, and thus light transmittance of the liquid crystal layer is changed. When the light transmittance is increased to be maximum transmittance, the LCD panel displays a white image of high luminance. However, when the light transmittance is decreased to be minimum transmittance, the LCD panel displays a black image of low luminance.

In order to improve an image display quality of the LCD device, an adaptive color correction (ACC) technology and a dynamic capacitance compensation (DCC) technology have been developed. In the ACC technology, color of the image is adapted to improve the image display quality. In the DCC technology, the response time of the liquid crystal molecules is improved to improve the image display quality. In the ACC and DCC technologies, compensation data mapping input data is stored in a memory such as a read-only memory (ROM) or a random access memory (RAM) as a lookup table (LUT), and the stored compensation data corresponding to the input data is outputted. When the input data provided from the exterior are applied to the LCD panel, the compensation data corresponding to the input data, which is stored in the LUT, are outputted. The compensation data compensate the color and the response time of the liquid crystal molecules.

The input data is applied in real time to the LCD panel while the LCD device is driving. The memory operates in real time continuously to read out the compensation data corresponding to the input data. The memory continuously operates while the LCD device operates. Thus, when the LCD device is used for a mobile terminal, the power consumption of the mobile terminal may be greatly increased.

### SUMMARY OF THE INVENTION

The present invention provides a method of compensating image data, which is capable of decreasing power consumption.

The present invention also provides an apparatus for compensating the image data.

The present invention also provides a display device having the apparatus.

Additional features of the invention will be set forth in the description which follows, and in part will be apparent from the description, or may be learned by practice of the invention.

The present invention discloses a method of compensating image data. A lookup table (LUT) memory storing compensating data that corresponds to received image data is disabled, when the received image data is substantially the same as previous image data that is stored in a cache memory. Compensating data that corresponds to the previous image data stored in the cache memory is outputted as compensating data that corresponds to the received image data. The previous image data stored in the cache memory and the compensating data is maintained.

The present invention also discloses an apparatus for compensating image data that includes a lookup table (LUT) memory, a cache memory, and a controlling part. The LUT memory stores compensating data that corresponds to received image data. The cache memory stores previous image data that is received prior to the received image data, and compensating data that corresponds to the previous image data. The controlling part disables the LUT memory and outputs the stored compensating data in the cache memory as compensating data of the received image data when the received image data is substantially the same as the previous image data stored in the cache memory.

The present invention also discloses a display device that includes a timing controlling part, a display panel, a data driving part and a gate driving part. The timing controlling part includes a lookup table (LUT) memory, a cache memory, and a memory controlling part. The LUT memory stores compensating data that corresponds to received image data. The cache memory stores previous image data that is received prior to the received image data, and compensating data that corresponds to the previous image data. The controlling part disables the LUT memory and outputs the stored compensating data in the cache memory as compensating data of the received image data when the received image data is substantially the same as the previous image data stored in the cache memory. The display panel includes a data line and a gate line that extend in a direction crossing the data line. The data driving part changes the compensating data into a data voltage and to output the data voltage to the data line. The gate driving part outputs a gate signal to the gate line.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a block diagram showing a display device in accordance with an exemplary embodiment of the present invention.

FIG. 2 is a block diagram showing a timing controlling part shown in FIG. 1.

FIG. 3 is a flowchart showing a method of driving a compensating part shown in FIG. 2.

FIG. 4 is a block diagram showing a memory controlling part shown in FIG. 2.

FIG. 5 is a timing diagram showing input/output signals of the memory controlling part shown in FIG. 4.

FIG. 6 is a block diagram showing a timing controlling part in accordance with an exemplary embodiment of the present invention.

FIG. 7 is a flowchart showing a method of driving a compensating part shown in FIG. 6.

### DETAILED DESCRIPTION OF THE ILLUSTRATED EMBODIMENTS

The present invention is described more fully hereinafter with reference to the accompanying drawings, in which exemplary embodiments of the present invention are shown. The present invention may, however, be embodied in many different forms and should not be construed as limited to the exemplary embodiments set forth herein. Rather, these exemplary embodiments are provided so that this disclosure will be thorough and complete, and will fully convey the scope of the present invention to those skilled in the art. In the drawings, the sizes and relative sizes of layers and regions may be exaggerated for clarity.

It will be understood that when an element or layer is referred to as being “on,” “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numerals refer to like elements throughout. As used herein, the term “and/or” includes any and all combinations of one or more of the associated listed items.

It will be understood that, although the terms first, second, third, etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular exemplary embodiments only and is not intended to be limiting of the present invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, exemplary embodiments of the present invention will be explained in detail with reference to the accompanying drawings.

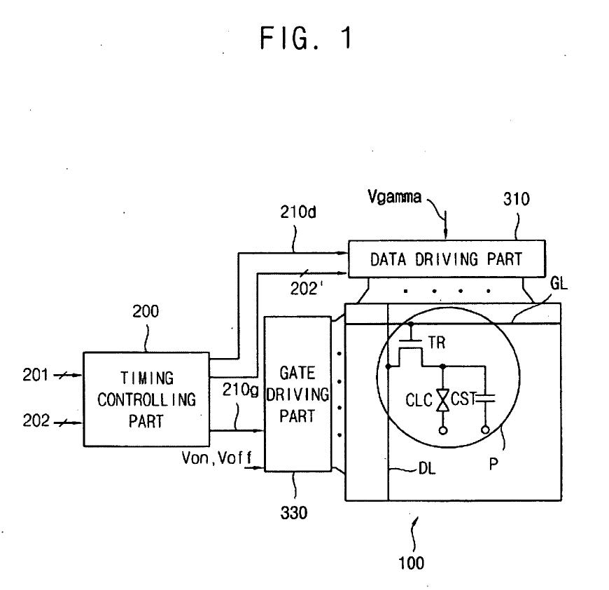

FIG. 1 is a block diagram showing a display device in accordance with an exemplary embodiment of the present invention.

Referring to FIG. 1, the display device includes a display panel 100, a timing controlling part 200, a data driving part 310, and a gate driving part 330.

The display panel 100 includes an array substrate (not shown), an opposite substrate (not shown), and a liquid crystal layer (not shown) disposed between the substrates. The display panel 100 may further include a plurality of data lines DL, a plurality of gate lines GL, and a plurality of pixels P. The gate lines GL extend in a direction crossing the data lines DL. The pixels P are electrically connected to the data and gate lines DL and GL. Each of the pixels P includes a switching element TR, a liquid crystal capacitor CLC, and a storage capacitor CST.

The timing controlling part 200 receives a synchronization signal 201 and image data 202. The image data 202 is digital data corresponding to gray-scales of an image. The timing controlling part 200 generates a plurality of timing signals for driving the display device using the synchronization signal 201. For example, the timing controlling part 200 generates data controlling signals 210d for controlling operation of the data driving part 310 and gate controlling signals 210g for controlling operation of the gate driving part 330. The data controlling signals 210d may include a horizontal synchronization signal, a load signal, an inversion signal, a data clock signal, etc. The gate controlling signals 210g may include a vertical synchronization signal, a gate clock signal, a gate enable signal, etc.

The timing controlling part 200 outputs compensation data 202′ corresponding to the inputted image data 202. The timing controlling part 200 includes a lookup table (LUT) memory, in which the compensation data corresponds to the image data 202 as an LUT type. A usage frequency of the LUT memory of the timing controlling part 200 is decreased using a plurality of cache memories, so that power consumption of the timing controlling part 200 may be decreased.

The data driving part 310 changes the compensation data 202′ into an analog data voltage based on the data controlling signals 210d. The data driving part 310 generates the data voltage using a gamma voltage Vgamma, and the data voltage is applied to the data line DL of the display panel 100.

The gate driving part 330 generates a gate signal based on the gate controlling signals 210g. The gate driving part 330 generates the gate signal using an on voltage Von and an off voltage Voff to apply the gate signal to the gate line GL of the display panel 100.

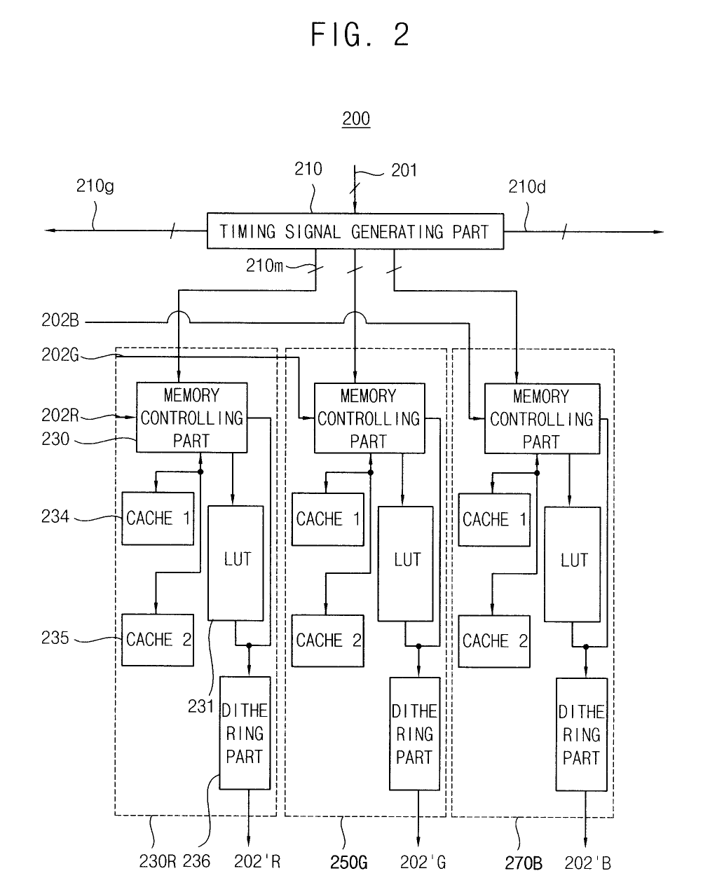

FIG. 2 is a block diagram showing a timing controlling part shown in FIG. 1.

Referring to FIG. 1 and FIG. 2, the timing controlling part 200 includes a timing signal generating part 210, a first data compensating part 230R, a second data compensating part 250G, and a third data compensating part 270B.

The timing signal generating part 210 generates the data controlling signals 210d, the gate controlling signals 210g, and memory controlling signals 210m based on the synchronization signal 201. The data controlling signals 210d include the horizontal synchronization signal, the load signal, the inversion signal, the data clock signal, etc., for controlling the operation of the data driving part 310. The gate controlling signals 210g include the vertical synchronization signal, the gate clock signal, the gate enable signal, etc., for controlling the gate driving part 330. The memory controlling signals 210m include a clock signal, a read enable signal, etc., for controlling memories of the first, second, and third data compensating parts 230R, 250G, and 270B.

The first data compensating part 230R outputs red compensating data 202′R to compensate the red data 202R. The second data compensating part 250G outputs green compensating data 202′G to compensate the green data 202G. The third data compensating part 230B outputs blue compensating data 202′B to compensate the blue data 202B.

The first data compensating part 230R includes a memory controlling part 230, an LUT memory 231, a first cache memory 234, a second cache memory 235, and a dithering part 236. Each of the second and third data compensating parts 250G and 270B has substantially the same structure as the first data compensating part 230R. Thus, any further repetitive explanations concerning the above mentioned elements will be omitted.

The memory controlling part 230 controls operation of the LUT memory 231, the first cache memory 234, and the second cache memory 235.

The received image data of ‘m’ bits and the compensating data having expanded bits corresponding to the inputted image data is stored in the LUT memory 231 as the one dimensional LUT type. For example, ten-bit compensating data corresponds to eight-bit image data expanded by two bits. The LUT memory 231 may be a ROM or a RAM.

Image data that is received prior to presently received image data and previous compensating data corresponding to the previously received image data is stored in the first and second cache memories 234 and 235.

The dithering part 236 dithers the compensating data having the expanded bits, so that the compensating data has original bits. For example, the dithering part 236 dithers the compensating data from ten bits into eight bits. In FIG. 1 and FIG. 2, the first data compensating part 230R includes the dithering part 236. Alternatively, the first data compensating part 230R may not include the dithering part 236, but the data driving part 310 may include a non-linear digital-to-analog converter (DAC) to change the compensating data of ‘n’ bits into a data voltage of ‘m’ bits, which corresponds to the compensating data.

The memory controlling part 230 compares the received image data and the image data stored in the first and second cache memories 234 and 235. When the received image data is substantially the same as the image data stored in the first or second cache memories 234 or 235, the memory controlling part 230 changes the operation of the LUT memory 231 to a disabled state. The memory controlling part 230 outputs the compensating data stored in the first and second cache memories 234 and 235 as the compensating data of the received image data.

When the received image data is different from the image data stored in the first cache memory 234 or the second cache memory 235, the memory controlling part 230 changes the operation of the LUT memory 231 to an enabled state. The LUT memory 231 outputs the compensating data corresponding to the received image data. The memory controlling part 230 updates the received image data and the compensating data outputted from the LUT memory 231 to the first cache memory 234 or the second cache memory 235.

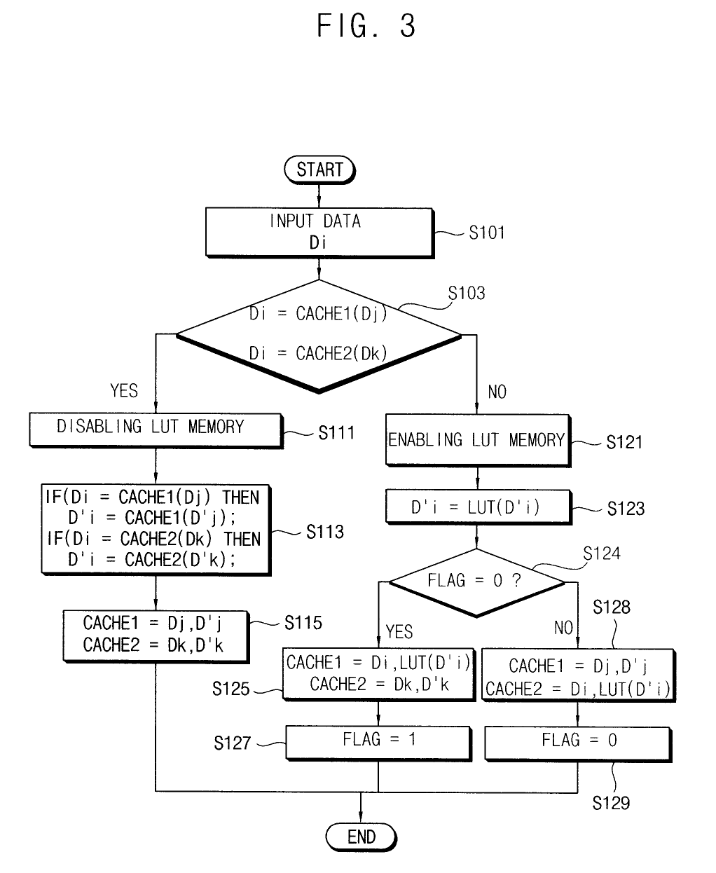

FIG. 3 is a flowchart showing a method of driving a compensating part shown in FIG. 2.

Referring to FIG. 2 and FIG. 3, i-th image data Di is applied to the memory controlling part 230 (step S101). The memory controlling part 230 compares the image data stored in the first and second cache memories 234 and 235 with the i-th image data Di (step S103). For example, the j-th image data Dj and j-th compensating data D′j corresponding to the j-th image data Dj are stored in the first cache memory 234, wherein j is smaller than i. The k-th image data Dk and k-th compensating data D′k corresponding to the k-th image data Dk are stored in the second cache memory 235, wherein k is smaller than i, and is different from j, and wherein i, j, and k are natural numbers.

When the received i-th image data Di is substantially the same as the j-th image data Dj or the k-th image data Dk, the memory controlling part 230 disables the operation of the LUT memory 231 (step S111).

The memory controlling part 230 outputs the j-th compensating data D′j stored in the first cache memory 234 or the k-th compensating data D′k stored in the second cache memory 235 as the compensating data D′i of the i-th image data Di (step S113).

The memory controlling part 230 maintains the data stored in the first and second cache memories 234 and 235 (step S115).

When the received i-th image data Di is different from the j-th image data Dj or the k-th image data Dk, the memory controlling part 230 enables the operation of the LUT memory 231 (step S121).

The memory controlling part 230 outputs the compensating data D′i stored in the LUT memory 231, which corresponds to the i-th image data Di, as the compensating data D′i of the i-th image data Di (step S123).

The memory controlling part 230 determines a flag of the first and second cache memories 234 and 235 (step S124). When the flag is 0, the memory controlling part 230 updates the i-th image data Di and the compensating data D′i to the first cache memory 234, and the second cache memory 235 is not updated to maintain the previously stored k-th image data Dk and the previously stored k-th compensating data D′k (step S125). Then, the memory controlling part 230 changes the flag from 0 to 1 (step S127).

The flag is data indicating the operation of the first and second cache memories 234 and 235. The first cache memory 234 or the second cache memory 235 is updated based on the flag. For example, when the flag is 0, the first cache memory 234 is updated. When the flag is 1, the second cache memory 235 is updated.

In the step S124, when the flag is 1, the memory controlling part 230 updates the i-th image data Di and the compensating data D′i to the second cache memory 235, and the first cache memory 234 maintains the previously stored j-th image data Dj and the previously stored j-th compensating data D′j (step S128). Then, the memory controlling part 230 changes the flag from 1 to 0 (step S129).

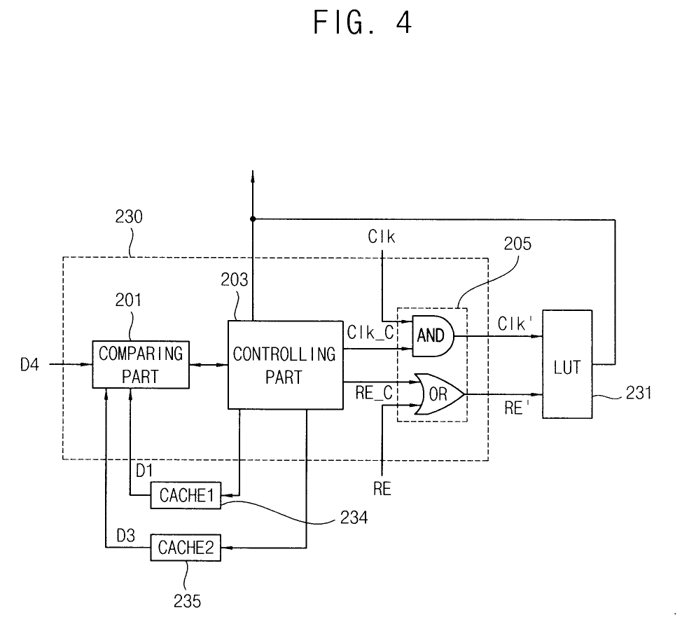

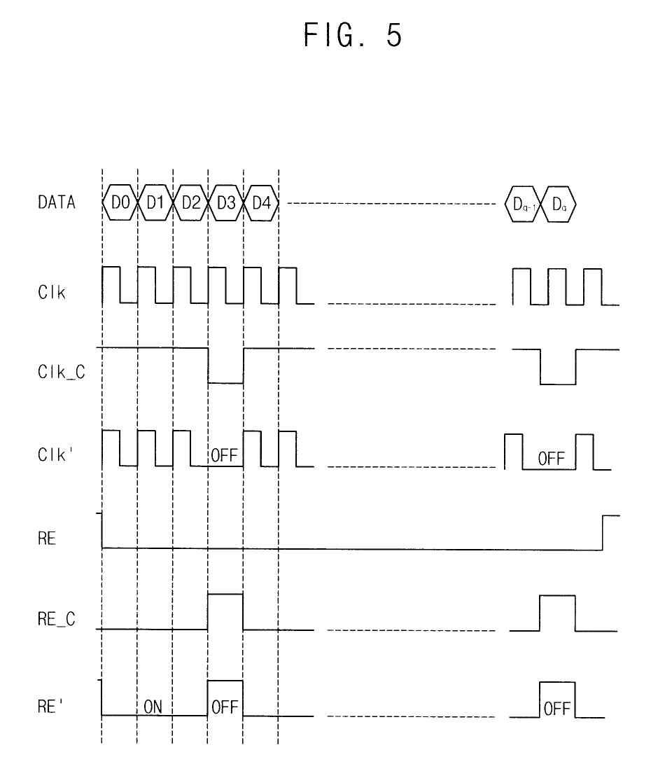

FIG. 4 is a block diagram showing a memory controlling part shown in FIG. 2. FIG. 5 is a timing diagram showing input/output signals of the memory controlling part shown in FIG. 4.

Referring to FIG. 4 and FIG. 5, the memory controlling part 230 includes a comparing part 207, a controlling part 203, and a calculating part 205. The comparing part 207 compares the previously stored data that is stored in the first and second cache memories 234 and 235 and the inputted image data.

The controlling part 203 generates a clock signal Clk for controlling the operation of the LUT memory 231, a clock controlling signal Clk_C for controlling a read enable signal RE, and a read controlling signal RE_C.

The calculating part 205 includes an AND gate and an OR gate. The AND gate AND receives the clock signal Clk and the clock controlling signal Clk_C and outputs a modified clock signal Clk′ to the LUT memory 231. The OR gate OR receives the read enable signal RE and the read controlling signal RE_C and outputs a modified read enable signal RE′ to the LUT memory 231.

Previous image data D1 and compensating data D′1 corresponding to the previous image data D1 are stored in the first cache memory 234, and previous image data D3 and compensating data D′3 corresponding to the previous image data D3 are stored in the second cache memory 235. Hereinafter, an embodiment in which present image data D4 is received and the received image data D4 is substantially the same as the previous image data D3 will be explained.

The comparing part 207 compares the received image data D4 with the previous image data D1 and D3 stored in the first and second cache memories 234 and 235. The controlling part 203 determines equality between the received image data D4 and the previous image data D3 stored in the second cache memory 235 based on the result of the comparison. Thus, the controlling part 203 generates the clock controlling signal Clk_C and the read controlling signal RE_C to output the clock controlling signal Clk_C and the read controlling signal RE_C. The clock controlling signal Clk_C and the read controlling signal RE_C have a low level and a high level, respectively, corresponding to the received image data D4.

When the clock controlling signal Clk and the clock controlling signal Clk_C have the high levels, respectively, the AND gate AND outputs a signal of the high level. When at least one of the clock signal Clk and the clock controlling signal Clk_C has the low level, the AND gate AND outputs a signal of the low level. Thus, the AND gate AND outputs the modified clock signal Clk′ having the low level corresponding to the received image data D4.

When the read enable signal RE and the read controlling signal RE_C have low levels, respectively, the OR gate OR outputs a signal of the low level. When at least one of the read enable signal RE and the read controlling signal RE_C has the high level, the OR gate OR outputs a signal of the high level. Thus, the OR gate OR outputs the modified read enable signal RE′ having the high level corresponding to the received image data D4.

Therefore, the LUT memory 231 is disabled while the compensating data corresponding to the received image data D4 is determined based on the modified clock signal Clk′ and the read enable signal RE′.

Therefore, when the received image data is substantially the same as the previous image data stored in the first and second cache memories 234 and 235, the LUT memory 231 does not operate, so that the power consumption may be decreased.

For example, when the memory such as a random access memory (RAM), a read only memory (ROM), etc., is in a read-disable state, power consumption of the memory corresponding to the clock signal of the low state may be about 5% of total power consumption of the memory. However, when the memory is in a read-enable state, power consumption of the memory corresponding to the clock signal of the high state may be about 95% of the total power consumption of the memory. Thus, when the period of the read-enable state is decreased, the power consumption of the memory may be decreased. In particular, a mobile display device using a limited battery may require the reduced power consumption.

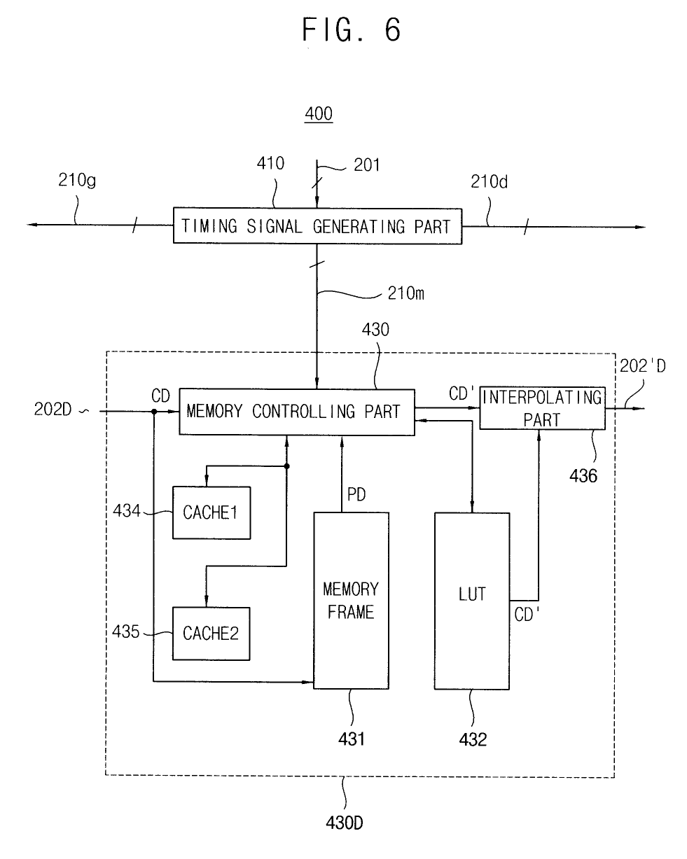

FIG. 6 is a block diagram showing a timing controlling part in accordance with another exemplary embodiment of the present invention.

Referring to FIG. 1 and FIG. 6, the timing controlling part 400 includes a timing signal generating part 410 and a data compensating part 430D.

The timing signal generating part 410 generates data controlling signals 210d, gate controlling signals 210g, and memory controlling signals 210m based on a synchronizing signal 201. The data controlling signals 210d may include a horizontal synchronizing signal, a load signal, an inversion signal, a data clock signal, etc., for controlling operation of the data driving part 310. The gate controlling signals 210g may include a vertical synchronizing signal, a gate clock signal, a gate enable signal, etc., for controlling operation of the gate driving part 330. The memory controlling signals 210m may include a clock signal, a read enable signal, etc., for controlling a memory of a data compensating part 430D.

The data compensating part 430D outputs received image data 202D as compensating data 202′D using previous image data.

For example, the data compensating part 430D includes a memory controlling part 430, a frame memory 431, an LUT memory 432, a first cache memory 434, a second cache memory 435, and an interpolating part 436.

The memory controlling part 430 controls the LUT memory 432, the first cache memory 434, and the second cache memory 435.

The frame memory 431 stores previous image data PD of a previous frame.

The LUT memory 432 stores present image data CD of a present frame, the previous image data PD of the previous frame, and compensating data CD′ of the present image data CD of the present frame as a 2-dimensional LUT type. For example, upper n-bit data of received m-bit data and n-bit compensating data corresponding to the received n-bit data of the previous frame, wherein m is greater than n, are stored in the LUT memory 432. The LUT memory 432 may be ROM or RAM.

The present image data of the present frame is stored in the first cache memory 434, and the present compensating data corresponding to the previous image data of the previous frame is stored in the second cache memory 435. For example, upper n-bit data CDj of the m-bit image data that is j-th received in the present frame F and j-th compensating data CD′j of the present frame F, which corresponds to the upper n-bit data PDj of m-bit image data PD that is j-th received in the previous frame F-1 are stored in the first cache memory 434. The j-th compensating data CD′j is the compensating data CD′ of n bits. Thus, data of 3n bits is stored in the first cache memory 434.

The interpolating part 436 interpolates the compensating data having reduced bits into compensating data of original bits. For example, the interpolating part 436 interpolates the compensating data CD′ of n bits, which corresponds to the input data CD of m bits, into the compensating data CD′ of m bits.

The memory controlling part 430 compares input data that includes the received present image data CD of the present frame and the previous image data PD of the previous frame with the stored data that is stored in the first and second cache memories 434 and 435. When the input data is substantially the same as the stored data stored in the first or second cache memories 434 and 435, the memory controlling part 430 disables the operation of the LUT memory 432. The memory controlling part 430 outputs the compensating data that is stored in the first and second cache memories 434 and 435 as the compensating data CD′ corresponding to the present frame.

When the input data is different from the stored data that is stored in the first or second cache memories 434 and 435, the memory controlling part 430 enables the operation of the LUT memory 432. The LUT memory 432 outputs the compensating data corresponding to the received image data CD of the present frame. The memory controlling part 430 updates the received image data CD of the present frame and the compensating data CD′ outputted from the LUT memory 432 to the first cache memory 434 or the second cache memory 435.

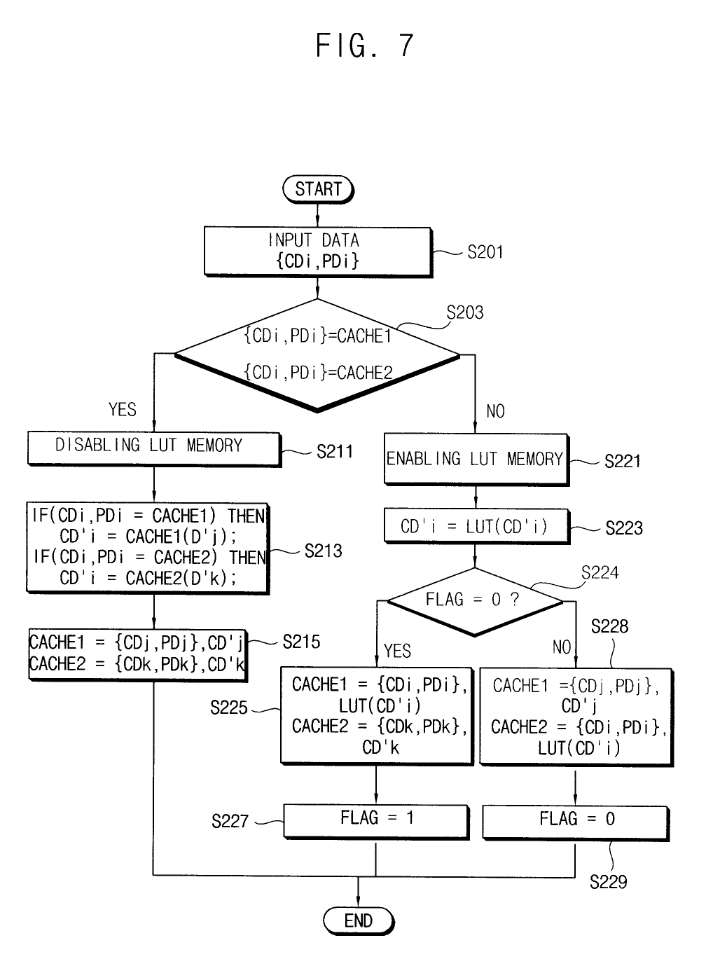

FIG. 7 is a flowchart showing a method of driving a compensating part shown in FIG. 6.

Referring to FIG. 6 and FIG. 7, the i-th image data CDi of the present frame F and the i-th image data PDi of the previous frame F-1 are inputted to the memory controlling part 430 as the input data CDi and PDi (step S201). The memory controlling part 230 compares the input data CDi and PDi with the stored data in the first and second cache memories 434 and 435 (step S203). For example, the j-th image data CDj of the present frame F and the j-th compensating data CD′j corresponding to the j-th image data PDj of the previous frame F-1 are stored in the first cache memory 434, wherein j is smaller than i. The k-th image data CDk of the present frame and the k-th compensating data CD′k corresponding to the k-th image data PDk of the previous frame F-1 are stored in the second cache memory 435, wherein k is smaller than i and is different from j, and wherein i, j, and k are natural numbers.

When the input data CDi and PDi are substantially the same as the stored data in the first cache memory 434 or the second cache memory 435, the memory controlling part 430 disables the operation of the LUT memory 432 (step S211).

The memory controlling part 430 outputs the j-th or k-th compensating data CD′j or CD′k stored in the first or second cache memory 434 or 435 as the compensating data CD′i of the i-th image data of the present frame F (step S213).

The memory controlling part 430 maintains the data stored in the first and second cache memories 434 and 435 (step S215).

When the input data CDi and PDi are different from the stored data in the first cache memory 434 or the second cache memory 435, the memory controlling part 430 enables the operation of the LUT memory 432 (step S221).

The memory controlling part 430 outputs the compensating data CD′i corresponding to the previously stored input data CDi and PDi in the LUT memory 432 as the compensating data CD′i of the image data CDi of the present frame F (step S223).

The memory controlling part 430 determines a flag of the first and second cache memories 434 and 435 (step S224). When the flag is 0, the memory controlling part 430 updates the input data CDi and PDi and the compensating data CD′i to the first cache memory 434 and the second cache memory 435 maintains the previously stored data CDk, PDk and CD′k (step S225). Then, the memory controlling part 230 changes the flag from 0 to 1 (step S227).

When the flag is 1 in the step S224, the memory controlling part 430 updates the input data CDi and PDi and the compensating data CD′i to the second cache memory 435 and the first cache memory 434 maintains the previously stored data CDj, PDj and CD′j (step S228). Then, the memory controlling part 430 changes the flag from 1 to 0 (step S229).

In the present exemplary embodiment, two cache memories are used. Alternatively, the number of the cache memories may be changed based on the logic of the timing controlling part, the power consumption, the credibility of the cache memory, etc. According to an exemplary embodiment of the present invention, the LUT memory storing the image data and the compensating data corresponding to the image data in one-to-one correspondence is used, so that the data and the compensating data are stored in the cache memory. Thus, repetitive memory reading operation is removed to decrease power consumption of the display device. It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A method of compensating image data, the method comprising:
disabling a lookup table (LUT) memory storing compensating data that corresponds to received image data, when the received image data is substantially the same as previous image data stored in a cache memory;
outputting compensating data that corresponds to the previous image data stored in the cache memory as compensating data that corresponds to the received image data; and
maintaining the previous image data stored in the cache memory and the compensating data.

2. The method of claim 1, further comprising:
enabling the LUT memory, when the received image data is different from the previous image data stored in the cache memory;
outputting the compensating data that corresponds to the received image data stored in the LUT memory; and
updating the received image data, as well as the compensating data from the LUT memory, to the cache memory.

3. The method of claim 2, wherein the cache memory comprises a plurality of cache memories, and
updating the received image data and the compensating data comprises:
updating the received image data and the compensating data in one of the cache memories; and
maintaining the stored data in a remaining cache memory of the cache memories.

4. The method of claim 3, wherein the received image data comprise the data of the present frame and the data of the previous frame, and the stored previous image data in the cache memory comprise the data of the present frame and the data of the previous frame.

5. An apparatus for compensating image data, the apparatus comprising:
a lookup table (LUT) memory that stores compensating data that corresponds to received image data;
a cache memory that stores previous image data that is received prior to the received image data and compensating data that corresponds to the previous image data; and
a controlling part that disables the LUT memory and outputs the stored compensating data in the cache memory as compensating data of the received image data when the received image data is substantially the same as the previous image data stored in the cache memory.

6. The apparatus of claim 5, wherein the controlling part enables the LUT memory and outputs the compensating data that corresponds to the received image data stored in the LUT memory when the received image data is different from the previous image data stored in the cache memory, and
the controlling part updates the received image data and the compensating data from the LUT memory to the cache memory.

7. The apparatus of claim 6, wherein the cache memory comprises a plurality of cache memories, and
the controlling part updates the received image data in one of the cache memories and the compensating data from the LUT memory, and the remaining cache memory maintains the stored data.

8. The apparatus of claim 7, wherein the received image data comprise data of the present frame and data of the previous frame, and the previous image data stored in the cache memory comprises the data of the present frame and the data of the previous frame.

9. A display device, comprising:
a timing controlling part that comprises:
a lookup table (LUT) memory to store compensating data that corresponds to received image data;
a cache memory to store previous image data that is received prior to the received image data and compensating data that corresponds to the previous image data; and
a memory controlling part to disable the LUT memory and output the stored compensating data in the cache memory as compensating data of the received image data when the received image data is substantially the same as the previous image data stored in the cache memory;
a display panel that comprises a data line and a gate line that extends in a direction that crosses the data line;
a data driving part to change the compensating data into a data voltage and to output the data voltage to the data line; and
a gate driving part to output a gate signal to the gate line.

10. The display device of claim 9, wherein the timing controlling part receives one image data of red data, green data, and blue data, and compensating data that corresponds to the received image data is outputted.

11. The display device of claim 10, wherein the timing controlling part receives image data of m bits, and outputs compensating data of n bits, n being greater than m, and n an m being natural numbers.

12. The display device of claim 11, wherein the timing controlling part further comprises a dithering part to change the n bit compensating data into m bit compensating data of the m bits.

13. The display device of claim 10, wherein the received image data comprises i-th image data of a present frame, and the cache memory comprises:
a first cache memory to store j-th image data and j-th compensating data that corresponds to the j-th image data; and
a second cache memory to store k-th image data and k-th compensating data that corresponds to the k-th image data,
wherein both j and k are smaller than i and k is different from j, and i, j, and k are natural numbers.

14. The display device of claim 13, wherein the memory controlling part outputs the j-th compensating data or the k-th compensating data as the compensating data of the i-th image data when the i-th image data is substantially the same as data stored in the first cache memory or the second cache memory, and
the memory controlling part maintains the data stored in the first cache memory and the second cache memory.

15. The display device of claim 13, wherein the memory controlling part outputs compensating data of the i-th image data, which is stored in the LUT memory, as the compensating data of the i-th image data when the i-th image data is different from the j-th image data or the k-th image data, and
the memory controlling part updates the compensating data of the i-th image data from the LUT memory to the first cache memory or the second cache memory.

16. The display device of claim 9, wherein the timing controlling part receives upper n-bit data of m-bit image data of a present frame and upper n-bit data of m-bit image data of a previous frame, and
the data compensating part outputs n-bit compensating data that corresponds to the upper n-bit data of the present frame,
wherein n is smaller than m, and n and m are natural numbers.

17. The display device of claim 16, wherein the timing controlling part further comprises an interpolating part to change the n-bit compensating data into compensating data of the m bits.

18. The display device of claim 16, wherein the cache memory comprises:
a first cache memory to store j-th image data of a present frame and j-th compensating data of the present frame, which corresponds to the j-th image data of a previous frame, when i-th image data of a present frame is received; and
a second cache memory to store k-th image data of the present frame and k-th compensating data of the present frame, which corresponds to the k-th image data of the previous frame,
wherein both j and k are smaller than i and k is different from j, and i, j, and k are natural numbers.

19. The display device of claim 18, wherein the memory controlling part outputs the j-th compensating data or the k-th compensating data stored in the first cache memory or the second cache memory as the compensating data of the i-th image data when the i-th image data of the present frame is substantially the same as data stored in the first cache memory or the second cache memory, respectively, and
the memory controlling part maintains the data stored in the first cache memory and second cache memory.

20. The display device of claim 18, wherein the memory controlling part outputs compensating data of the i-th image data stored in the LUT memory as the compensating data of the i-th image data when the i-th image data of the present frame is different from the data stored in the first cache memory or the second cache memory, and
the memory controlling part updates the i-th image data of the present frame, the i-th image data of the previous frame and the compensating data of the i-th image data from the LUT memory to the first cache memory or the second cache memory.
